(19) United States
(12) Patent Application Publication
(10) Pub. No.: US 2015/0206092 A1
(43) Pub. Date: Jul. 23, 2015

(54) IDENTIFICATION OF MULTI-CHANNEL CONNECTIONS TO PREDICT ESTIMATED WAIT TIME

(71) Applicant: Avaya, Inc., Basking Ridge, NJ (US)

(72) Inventors: George Erhart, Loveland, CO (US); Valentine C. Matula, Granville, OH (US); David Skiba, Golden, CO (US)

(73) Assignee: Avaya, Inc., Basking Ridge, NJ (US)

(21) Appl. No.: 14/160,361

(22) Filed: Jan. 21, 2014

(51) Int. Cl. G06Q 10/06

(52) U.S. Cl. CPC G06Q 10/063114

(57) ABSTRACT

Contact centers handle contacts from any number of channels. One agent may be simultaneously handling several chats, emails, or other messages. Customers behind the contact often want to know how long of a wait time they are likely to experience before an agent begins to address their inquiry. Herein, techniques are provided whereby contacts currently, and/or enqueued, for one or more agents are examined to determine an estimated effort for each task. One message may represent a number of tasks each having an associated time estimate. Furthermore, messages from one channel may be more time consuming than messages from another channel. Such factors, and others, are considered and the customer may then be notified of an estimated wait time and, optionally, notified if another channel may provide a more expeditious option.

### FIELD OF THE DISCLOSURE

The present disclosure is generally directed toward contact center operations and estimating the wait time until a contact is accepted by an agent.

### BACKGROUND

Contact center systems incorporate mechanisms to provide an estimate of how long a customer will have to hold until he or she is serviced by an agent. Typically, an assessment of how many calls are in a waiting queue determines how long it will take for the call to be answered. Some, more sophisticated systems, may take into account the agent's skills, customer attributes, work history, topics, etc. to make a more accurate time estimate for customers who call into the contact center.

For incoming telephone calls, the estimated wait time may be a simple aggregation, such as multiplying the number of preceding calls by an average of the wait times experienced by a number of previous callers. Contact centers may not be so monolithic and assume that all calls, customers, and agents have the same needs and abilities.

Even with the prior art systems, calculating hold times continues to be a challenge for contact centers.

### SUMMARY

It is with respect to the above issues and other problems that the embodiments presented herein were contemplated.

Prior art contact center systems provide estimated wait times for a single channel, voice in particular, without any consideration for additional channels, including non-voice channels, such as text-based chat, email, video chat, social media posts, etc. The embodiments herein provide a predictive mechanism for estimating wait time that also considers channel type, problem type, customer attributes, sentiment, and fluidity of conversation.

Calculating hold times is often referred to as Estimated Wait Time (“EWT”). Generally, a contact center system calculates and provides an EWT to a customer indicating how long he or she has to wait for assistance. Prior art systems have a look-ahead mechanism that detects how many calls are in queue, what skills are available to process the calls, and then runs a simple algorithm to determine a time-to-answer based on the available information. This solution may be insufficient for multi-channel wait time estimation.

In certain embodiments disclosed herein, an EWT may be determined, at least in part, by agent performance (e.g., how long an agent takes per ticket/engagement/contact), agent skills, agent metrics, where in a process a call may be, work history, subject matter, customer attribute, topic, and so on. Additionally, the embodiments include the ability to fine-tune the time estimate to make it more accurate. For example, examining detailed, real-time and past performance data, including assessment of context, content, changes in topic, and other attributes may provide for a more accurate, and timely, EWT. As a benefit of the disclosure herein, the mechanism is able to estimate general agent time per specific topic, regardless of whether or not the specific topic is one of many topics to be handled within a single contact or the specific topic belongs to one contact of many contacts that the agent is currently processing.

The proposed calculation for EWT may consider one or more of: content analysis, complexity, and agent mastery. Content analysis may further include evaluating calls in process, calls in non-voice queues, and history of prior transactions. The complexity may be scored by evaluating: topic parameter (e.g., iPhone 4 or iPhone 5), customer or customer attributes, agent performance, and convolution. Agent mastery may be considered by evaluating: mastery of topic, mastery of channel, and difficulty of topic.

Certain embodiments disclosed herein provide the ability to monitor all channels and agents for the attributes above and create a central model of behavior. This may be referenced during new contact interactions to determine the best options for routing. Furthermore, the embodiments disclosed provide for periodic and/or real-time evaluation of an interaction. As a contact interaction progresses, and as more information is received about the nature of the contact, the EWT may consider updated information regarding the estimated time to complete the current contact and update the EWT for subsequent contacts accordingly.

In one embodiment, changes in topic are detected and processed. For example, a contact may start a conversation with an agent with respect to one topic. Then, as that transaction completes, the contact brings up a second topic. This may represent an entirely new transaction and the system may then detect the change, extend the conversation time, and update the EWT accordingly. A topic change may occur on any channel. In the case of contacts using an email channel, a single email might include multiple topics and the estimate of time to complete the contact may then include the time to address each topic.

The embodiments herein may provide EWT as well as proffer other channel choices for faster resolution. For example, the time to resolve an issue which requires a significant amount of back-and-forth between the agent and the contact may take more time on an email channel and therefore, the system may recommend that the agent change to a telephone or text-chat channel to accelerate resolution. In addition to changing channels, the use of Web Real-Time Communication (“WebRTC”) may be employed as another means to advance a work task by transferring the contact to a WebRTC channel and hopefully resolve the work task faster than what might be accomplished within another channel.

In one embodiment, a method is disclosed, comprising: identifying a first work task for which an estimated wait time will be determined; identifying a set of work tasks received by a contact center having a higher priority to the first work task; determining, for each work task within the set of work tasks, an estimated time to complete that is based on each work task being processed by a single multi-tasking agent; based on the estimated time to complete determined for each work task within the set of work tasks, determining the estimated wait time for the first work task; and communicating the estimated wait time for the first work task to a first customer associated with the first work task.

In another embodiment, a system is disclosed, comprising: a processor; and a communications interface; and wherein the processor is configured to: send and receive data via the communications interface; identify a set of work tasks received by a contact center having a higher priority to a first work task; determine, for each work task within the set of work tasks, an estimated time to complete that is based on each work task being processed by a single multi-tasking agent; based on the estimated time to complete determined for each work task within the set of work tasks, determining the estimated wait time for the first work task; and communicate, via the communications interface, the estimated wait time for the first work task to a first customer associated with the first work task.

In yet another embodiment, a non-transitory medium is disclosed with instructions thereon that when read by a computer cause the computer to: identify a first work task for which an estimated wait time will be determined; identify a set of work tasks received by a contact center having a higher priority to the first work task; determine, for each work task within the set of work tasks, an estimated time to complete that is based on each work task being processed by a single multi-tasking agent; based on the estimated time to complete determined for each work task within the set of work tasks, determine the estimated wait time for the first work task; and communicate the estimated wait time for the first work task to a first customer associated with the first work task.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a task processing diagram in accordance with embodiments of the present disclosure;

FIG. 3 depicts a process in accordance with embodiments of the present disclosure; and

FIG. 4 depicts a process for calculating a first and second EWT in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedent.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

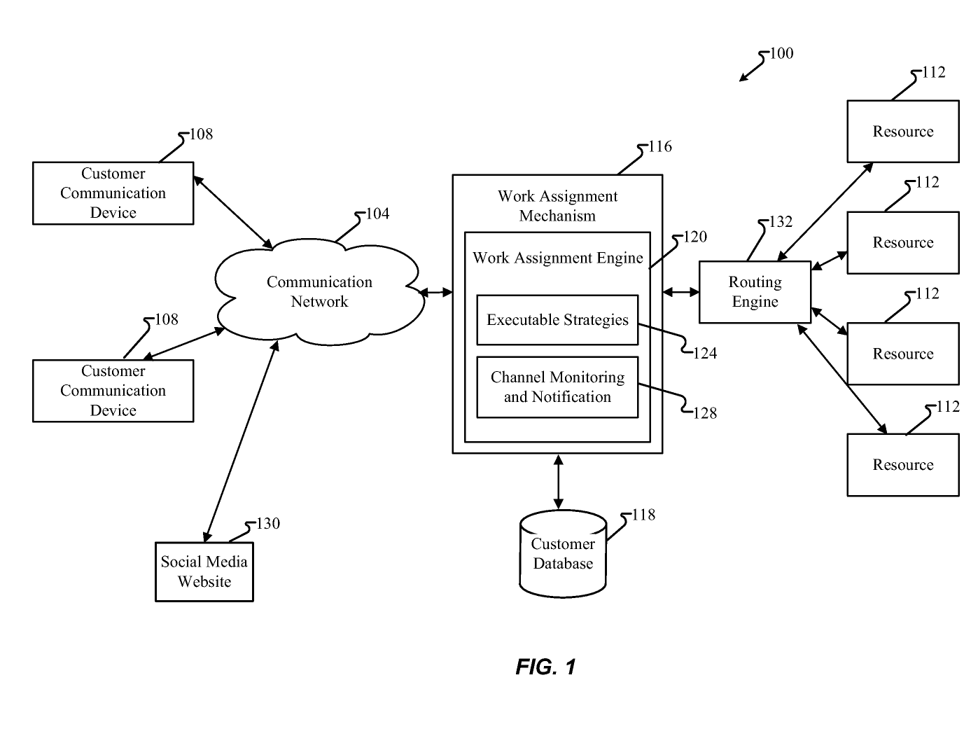

FIG. 1 depicts an illustrative embodiment of communication system 100 in accordance with at least some embodiments of the present disclosure. Communication system 100 may be a distributed system and, in some embodiments, comprises communication network 104 connecting one or more communication devices 108 to a work assignment mechanism 116, which may be owned and operated by an enterprise administering a contact center in which a plurality of resources 112 are distributed to handle incoming work tasks (in the form of contacts) from customer communication devices 108.

In accordance with at least some embodiments of the present disclosure, communication network 104 may comprise any type of known communication medium or collection of communication media and may use any type of protocols to transport messages between endpoints. Communication network 104 may include wired and/or wireless communication technologies. The Internet is an example of communication network 104 that constitutes and Internet Protocol (IP) network consisting of many computers, computing networks, and other communication devices located all over the world, which are connected through many telephone systems and other means. Other examples of communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, communication network 104 may comprise a number of different communication media such as coaxial cable, copper cable/wire, fiber-optic cable, antennas for transmitting/receiving wireless messages, and combinations thereof.

Communication devices 108 may correspond to customer communication devices. In accordance with at least some embodiments of the present disclosure, a customer may utilize their communication device 108 to initiate a work task, which is generally a request for a processing an agent. Illustrative work tasks include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work task may be in the form of a message or collection of messages transmitted over communication network 104. For example, the work task may be transmitted as a telephone call, a packet or collection of packets (e.g., IP packets transmitted over an IP network), an email message, an Instant Message, an SMS message, video, a fax, and combinations thereof. In some embodiments, the communication may not necessarily be directed at the work assignment mechanism 116, but rather may be on some other server in communication network 104 where it is harvested by work assignment mechanism 116, which generates a work task for the harvested communication. An example of such a harvested communication includes a social media communication that is harvested by work assignment mechanism 116 from a social media network or server. Exemplary architectures for harvesting social media communications and generating work tasks based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work task may depend upon the capabilities of communication device 108 and the format of the communication. In particular, work tasks are logical representations within a contact center of work to be performed in connection with servicing a communication received at the contact center (and more specifically work assignment mechanism 116). The communication may be received and maintained at work assignment mechanism 116, a switch or server connected to work assignment mechanism 116, or the like until a an agent is assigned to the work task representing that communication at which point work assignment mechanism 116 passes the work task to routing engine 132 to connect communication device 108 which initiated the communication with the assigned an agent.

Although the routing engine 132 is depicted as being separate from work assignment mechanism 116, routing engine 132 may be incorporated into work assignment mechanism 116 or its functionality may be executed by work assignment engine 120.

In accordance with at least some embodiments of the present disclosure, communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, kiosk, automated teller machine, or combinations thereof. In general each communication device 108 may be adapted to support video, audio, text, and/or data communications with other communication devices 108 as well as processing resources 112. The type of medium used by the communication device 108 to communicate with other communication devices 108 or processing resources 112 may depend upon the communication applications available on the communication device 108. Additionally, a customer may utilize their customer communication device 108 to post and receive messages on social media website 130 and thereby may be used as a means to initiate work tasks and be provided resolution to those work tasks, unless transferred to a different channel.

In accordance with at least some embodiments of the present disclosure, the work task is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work tasks. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

More specifically, the work assignment engine 120 comprises executable strategies 124 that, when executed, enable the work assignment engine 120 to determine which of the plurality of processing resources 112 is qualified and/or eligible to receive the work task and further determine which of the plurality of processing resources 112 is best suited to handle the processing needs of the work task. In situations of work task surplus, the work assignment engine 120 can also make the opposite determination (i.e., determine optimal assignment of a work task resource to a resource). In some embodiments, the work assignment engine 120 is configured to achieve true one-to-one matching by utilizing bitmaps/tables and other data structures.

In accordance with at least some embodiments of the present disclosure, the work assignment engine 120 may be configured to execute one or several executable strategies 124 to make work assignment decisions. As will be discussed in further detail herein, the work assignment engine 120 may comprise a plurality of executable strategies 124, where one or more of the executable strategies 124 include one or many tasks that are performed by the work assignment engine 120 during execution of the executable strategy 124. The order or manner in which the tasks of a strategy 124 are executed by the work assignment engine 120 may be defined by rules or policies, which may also be included in the executable strategy 120. Non-limiting examples of tasks that can be included in an executable strategy 124 include, without limitation, any of the following actions:

For a Resource: Add, Remove, Change a State (e.g., READY, ON DUTY, NOT READY, etc.), Update, Enable, Disable, Qualify Resource, Qualify Match, Score Resource, Begin, Finish, Set New Best, Enqueue, Dequeue, Accept, Reject, and Timeout;

For a Work task: Add, Remove, Update, Cancel, Begin, Finish, Next Evaluation, Find Resource, Qualify Work, Qualify Match, Score Work, Set New Best, Enqueue, Dequeue, Accept, Reject, Requeue, Ready, Not-Ready, Complete, and Time-Out;

For a Service: Add, Remove, Update, and Enable;

For Determining a Best Match: Assign Work To Resource, and Determine Well-Matched; and

For Determining Context: Heartbeat Failure, Customer Score, Custom Qualify, Custom Well Matched, Ready Res Service Capabilities, Not Ready Res Service Capabilities, Begin Resume, Begin Service Enable, Metric Sample, Intrinsic Sample, Intrinsic Sample All, Compute Requeue Metrics, Compute Enqueue Metrics, Compute Dequeue Metrics, Add Existing, Completed, Compute Rejected Metrics, Compute Accepted Metrics, Accepted, Rejected, Requeued, Compute Abandoned Metrics, and Compute Completed Metrics.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing via a communications channel. A particular customer may be associated with a work task, such as via caller-ID, email address, name provided, or other means and associated with an entry in customer database 118. Customer database may provide one or more of customer attributes and customer history to assist in the processing and/or routing of a work task.

In another embodiment, channel monitoring and notification 128 provides notifications to interested components, such as to work assignment mechanism 116, upon an activity on a channel, such as a posting on a social media website 130 and/or messages received on communications network 104.

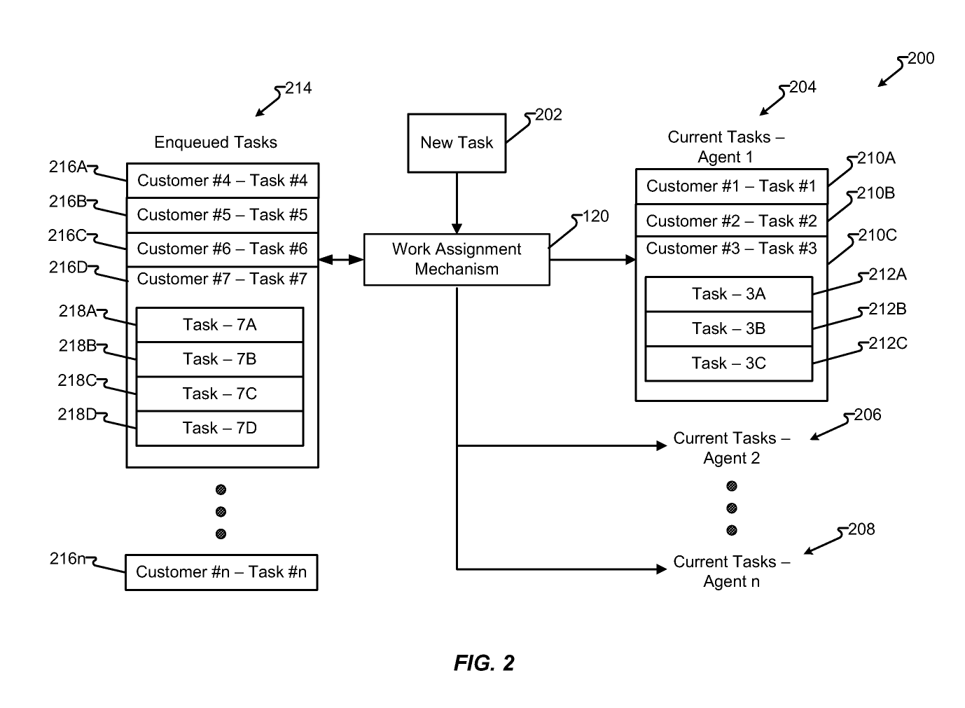

FIG. 2 depicts diagram 200 illustrating EWT determination in accordance with at least some embodiments of the present disclosure. In one embodiment, new task 202 enters a system, such as system 100. New task 202 represents a contact from a customer that requires work from at least one resource 112. New task 202 may then be processed by work assignment mechanism 120. Work assignment engine 120 may perform, among other tasks, routing of work tasks to a particular resource 112, such as to become one of work tasks 210, or enqueuing the work task in enqueued tasks 214 if a qualified agent is not available, and become one of enqueued work tasks 216.

In one embodiment, work assignment engine 120 provides an EWT for new task 202 and/or one or more enqueued tasks 214. In other embodiments, one or more of work assignment mechanism 116, routine engine 132, and/or another dedicated or shared component may compute the EWT for new task 202 and/or one or more of enqueued tasks 214. The customer associated with new task 202 and/or one or more of enqueued tasks 214 may then be informed of the EWT initially, as it changes, periodically, and/or upon request. Optionally, agents, supervisors, and/or other interested parties may be informed of an EWT for a particular work task or tasks, exceptional work tasks (e.g., number of work tasks having an EWT over a predetermined threshold), and/or other work tasks such as may be used for reporting, planning, and/or estimating contact center behavior.

A contact center operating communication system 100 may employ a number of resources 112. The embodiments herein are generally directed towards resources 112 which represent human agents as human agents have a limited capacity to accept new work tasks. In contrast, automated agents (e.g., IVR systems) rarely limit contact center operations. However, it should be noted that the embodiments herein may be applied to any resource 112 which may be performance constrained such that at least one work task cannot be accepted until at least one prior work task is concluded.

One particular resource 112 may have current work tasks 204 comprising work tasks 210, which are being current worked. Current tasks 204 comprises a number of tasks 210, including task 210C which comprises a number of work subtasks 212 associated with work task 210C. Other resources 112 are similarly working current work tasks 206, 208. Work tasks which are waiting for a resource 112 are enqueued in enqueued tasks 214 and comprise enqueued tasks 216.

In one embodiment, the determination of an EWT for any pending work task is based, at least in part, on the estimated duration to complete one or more current tasks 204 so that a particular resource 112 is able to accept the next work task. As can be appreciated, if current tasks 204 is in a less-than-full state, a next work task may be accepted into current tasks 204. For example, enqueued task 216A may be accepted by resource 112 and moved to current tasks 204, thereby indicating EWT enqueued task 216A is, or is substantially, zero. Additionally, certain work tasks may be processed in parallel with another work task, such that all or a portion of one work tasks overlaps with at least one other work task. Therefore, a next work task may be accepted as soon as any position in current task 204 becomes available. In other embodiments, work tasks are processed serially whereby one task, once started, is worked exclusively and to completion before working any other work tasks. As will be described in more detail below, new information may cause a particular work task to switch between parallel and serial processing.

In one embodiment, the EWT for any pending work task is determined by estimating the time required for one or more resources 112 can conclude current tasks, such as current tasks 204, 206, 208, and any preceding enqueued tasks 214 and thereby be available to accept the work task for which the EWT is to be determined. In other embodiments, skills, abilities, and availabilities of resources 112 and requirements of work tasks are not homogenous and additional means are employed to determine the EWT.

In one embodiment, the EWT is representative of the customer perspective whereby a EWT of zero means the customer's work tasks is now being processed by a resource 112 (e.g., a call is being answered, an email or text message is being read, etc.). In another embodiment, an EWT zero refers to a time in which work on a discrete tasks has begun. For example, a work task associated with answering a customer's call having an associated history, may require the agent to first review the history prior to answering the call. Accordingly, an EWT of zero may refer to the resource beginning the review of the associated history.

In another embodiment, the EWT is determined based on a set of tasks having a higher priority to the task for which the EWT is to be determined. Generally, the higher priority task is a task that was received prior to the task for which the EWT is to be determined. However, in other embodiments, a newer task may have a higher priority (e.g., high-value customer, emergency situation, etc.) and the EWT for a work task is then determined based on the higher priority tasks being processed prior to the task for which the EWT is to be determined.

The determination of which work tasks, or sets of work tasks, must be completed in order for a resource 112 to accept a next work task may also determine, at least in part, the EWT. In one embodiment, in order to determine the EWT for a next work task, such as enqueued task 216A, the completion of any one of work tasks 210A, 210B, or 210C determines the EWT for enqueued task 216A. In another embodiment, a set of subtasks must each be completed before the work task is considered complete. For example, work task 210C may comprise a number of subtasks 212A-C which must all be completed before work task 210C is complete.

Determining an EWT for a work task that is more deeply enqueued, and thereby not the next work task, may additionally require consideration of the time to complete a number of preceding work tasks. In one embodiment, a number of enqueued tasks 214 may be waiting for processing. Certain work tasks, such as work tasks 216A, 216B, 216C may be discrete tasks that can be assigned to a particular resource 112 as resources 112 becomes available. Therefore, the EWT is determined, in part, on ones of work tasks 216A-216C being completed. For example, one resource 112 may be assigned work tasks 216A, 216B, and 216C, and upon completing any one of work tasks 216A, 216B, and 216C, is assigned 216D, unless already assigned to a second resource 112. Therefore the EWT may reflect the time estimated for the first of work tasks 216A, 216B, and 216C to be completed. However, a set of tasks, such as work subtasks 218A-218D are associated and require common assignment to a resource 112. Therefore, a resource 112 who is assigned task 216D may not be available to accept a new work task until each of work subtasks 218A-218D are completed. Accordingly, the EWT is determined on all of work tasks 218A-218D being completed. In yet a further embodiment, new information may occur which causes the EWT to be recalculated. For example, an EWT for a particular work task may depend upon task work 210B being completed. However, if work task 210B may enter a state (e.g., waiting for a customer to retrieve information or perform an action), a new work task may be accepted in parallel with work task 210B. Accordingly, the EWT may be updated upon determining that work task 210B may be processed in parallel to another task.

One or more of enqueued tasks 214 may be allocated to a particular resource 112 or set of resources 112 (e.g., agent #123, agents fluent in French, experts in a certain technology, sales agents, etc.). Generally, contact centers strive to process work tasks in first-in-first-out (“FIFO”) order, however, other factors may determine the order in which work tasks are processed. For example, enqueued task 216A may be the oldest work task in enqueued tasks 214. However, if newer work task 216B requires one resource 112, having a set of skills that is currently available, but enqueued task 216A requires another resource 112, having a set of skills that is not currently available, work task 216B may be assigned to the available resource 112 ahead of work task 216A. Accordingly, determining what resources are required for a particular work task, and the availability of those resources, is one factor which may be use to determine the EWT for one or more enqueued work tasks 216 and/or new task 202.

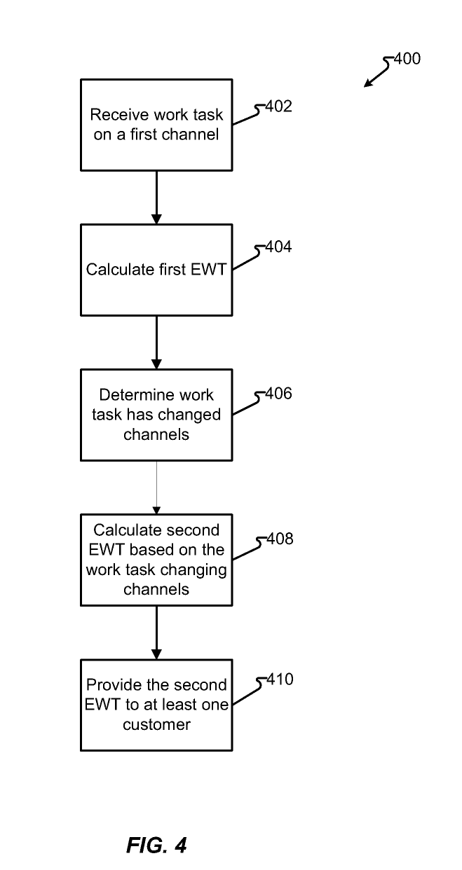

In one embodiment, work assignment mechanism 120 receives new task 202 and/or accesses enqueued tasks 214 for which an EWT is to be determined. A processor running on one or more components may then execute instructions to determine the EWT. For example routing engine 132, channel monitoring and notification 128, and/or another dedicated or shared component may be employed to determine the EWT. With a number of resources 112 processing work tasks, work tasks being able to be processed in parallel or serially and potentially changing, any particular EWT may be dynamic and reevaluated accordingly. The EWT may be further complicated by a work task changing channels, which is discuss in more detail with respect to FIG. 4. A work task may change channels with the objective of accelerating resolution. However, other objectives, such as improvement of the accuracy of the resolution may also be considered. Therefore, a means to predict and/or detect a channel change may be implemented. For example, an automated resource, supervisor or the agent may determine a channel change is likely and trigger a signal that causes the EWT to be recalculated.

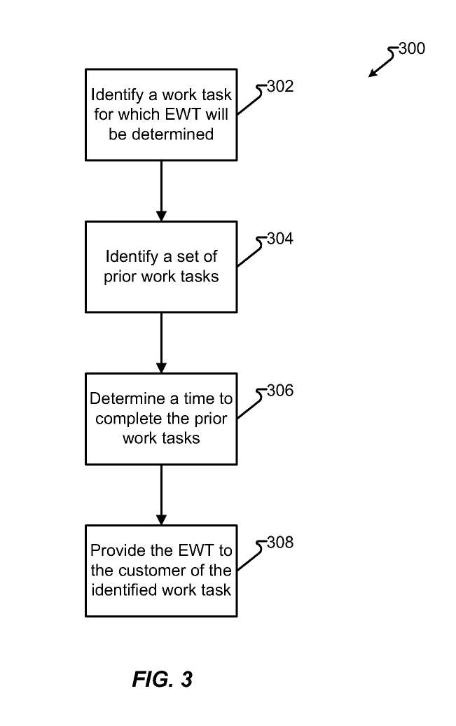

FIG. 3 depicts process 300 in accordance with embodiments of the present disclosure. In one embodiment, step 302 identifies a work task for which EWT will be determined. The identified work task may be a newly arrived work task or a currently enqueued work task. Additionally, the work task may also be hypothetical work task, such as to provide modeling information. Step 304 identifies a number of prior work tasks. Without any intervening work tasks, the identified work task will have an EWT indicative of the time that one or more prior work tasks will take to be completed. With additional intervening work tasks, the identified work task may have an EWT indicative of the time that one or more prior work tasks, and one or more prior enqueued work tasks, will take to be completed. Accordingly, step 306 determines a time to complete the prior work tasks such that the identified work task may begin being processed by an agent, such as a human resource 112. The EWT is then communicated to the customer by step 308.

The ability of an agent to accept a new work task may depend on the channel or other attribute determining if at least one work task can be processed in parallel or serially to at least one other work task. For example, an agent may be able to process a number of text-based work tasks (e.g., emails, SMS, etc.) simultaneously but telephonic work tasks may require serial processing.

In one embodiment, work tasks durations are estimated serially. For example, one work task, such as work task 210C, is associated with “Customer #3” and comprises three subtasks 212A-212C. Task 210C may be considered incomplete until all subtasks 212A-212C have been completed. Serial processing may be determined, in part, by the channel. For example, if work task 210B is received via telephonic, video, or other real-time interactive channel, the customer and/or the agent processing task 210B may find it disruptive if an agent places the customer on hold to process, for example, work task 210C. In another embodiment, serial processing may be implemented for efficiency or other advantage. For example, work task 210C may be an email comprising subtasks 212A-212C. While the an agent may or may not be permitted to switch back to another tasks certain efficiencies may be realized if all of subtasks 212A-212C are processed serially. Tasks designated as parallel or serial may change during processing and further affect the EWT of a subsequent task.

In another embodiment, work tasks durations are estimated in parallel. At least one work task may be available to be processed in parallel with another work task. In one example, work tasks 210 may represent a text-channel message whereby the completion of any one of work tasks 210 allows the agent to accept a new task. Accordingly, an agent working tasks 210A, 210B, and 210C and completes any one, may accept enqueued task 216A. In yet another embodiment, a mix of parallel and serial processes may be provided. As another example, work task 210C includes work subtask 212C, in which the customer restarts their computer, a process that may require the agent to do little more than wait. Even if work task 210C is a voice call, and generally considered to be a serial task, the agent may spend the otherwise idle time on another tasks, such as work task 210B.

In addition to the sequencing of a number of work tasks, determining the duration of one or more tasks may, in part, determine the EWT for a subsequent task. In one embodiment, the EWT depends on the completion of work task 210A. The customer associated with work task 210A is identified and is associated with tasks having a known, or estimated, duration. For example, a specific customer may be first identified, such as by their name, account number, caller identification, email address, Twitter handle, and so on. A history, such as that stored in customer data base 118, social media website 130, or other source may be accessed to provide historical information associated with the customer. The customer him or herself may have attributes indicating a work task duration (e.g., difficulty comprehending instructions, non-English speaker, technical novice, complex topic, etc.). In another embodiment, the customer may be associated with a process and the work task associated with a particular step in the processes. For example, a customer seeking a refund for a returned item may need to call (e.g., create a work task) and provide an agent with a shipment tracking number for the returned item. Once the customer is identified and associated a next step in the return process, the estimated duration associated with that particular work task may then be used, in part, to determine an EWT for a subsequent work task.

The specific identification of a customer may not be possible, however, customer attributes may still be determined and utilized to determine a EWT. For example, a customer who is known to be using an automated kiosk in the first class lounge of an airport may provide certain identifiable attributes (e.g., on one of a set of potential flights, a high revenue customer, etc.). A customer who calls, posts, or emails a specific address (e.g., LostMyCreditCard@mybank.com) or uses a particular telephone number (e.g., account information: (800) 000-0001, billing (800) 000-0002, etc.), may similarly be identified as having certain attributes and the estimated duration of likely work tasks associated with those attributes used, in part, to determine an EWT.

In another embodiment, the duration estimated for any one or more tasks may be an average, mean, mode, range, or other value or aggregation of similar tasks determined as a matter of design choice.

In another embodiment, attributes associated with the work task itself may be determined. For example, sentiment of a work task may, in part, determine a duration. For example, two customers may be inquiring into a product warranty with very different sentiment (e.g., “Does the warranty cover the display?” versus, “This piece of junk! You're going to replace my display under warranty, right!?”). An agent with a particular skill in handling angry customers may be selected to address negative sentiment work tasks and have a different availability than other agents. Accordingly, the time to complete such a task may be determined, at least in part, by the sentiment. In addition to sentiment, the complexity of the work item, difficulty of the work item or other work item attribute may be utilized to determine, in part, an EWT for a subsequent work task.

In another embodiment, the skills of one or more agents determines an estimated completion time of a preceding tasks and, in part, determines an EWT for a subsequent task. One agent may have a high degree of skill with respect to particular work task, however that agent may be unavailable. An available, or soon to be available, agent may have less skill in that particular area but have enough skill, if given additional time, to successfully resolve the issue.

As can be appreciated, the combination of possible processing paths for any one work task may be quite large and dynamic. In one embodiment, detecting a change in topic is provided. While a work task may be associated with one particular topic, the customer may change topics, such as to ask additional questions. For example, after resolution of a battery-life issue with a cell phone, the customer may add additional questions regarding service plans, for which re-calculating the EWT for a subsequent work task may be required.

Another skill an agent may have, in varying degrees, is skill with a particular channel. An agent may be highly skilled in written language and, therefore, be able to quickly receive and convey information in a written channel (e.g., email, text chat, etc.). However, a video, telephonic, or other live voice conversation may be more difficult and represent a longer EWT for a subsequent work task.

Additionally, agents may have skills based on a combination of channels. For example, one agent may have simultaneous process several text chats, a phone call, and be reading an email. A second agent may be able to process only two text chats simultaneously. Therefore, if the second agent is assigned a third text chat, the EWT for a subsequent text chat may be recalculated to reflect that longer duration predicted to resolve any one of the text-chats.

FIG. 4 depicts process 400 for calculating a first and second EWT in accordance with embodiments of the present disclosure. In one embodiment, step 402 receives a work task on a first channel. Step 404 calculates a first EWT. Step 406 determines the channel has changed. Step 408 calculates a second ETW, based at least in part on the work task changing from a first to a second channel. Step 410 then provides the EWT to at least one customer.

In another embodiment, the customer associated with the work task may initiate the change, such as when a customer provides messages on a number of channels. For example, the customer initiates a work task on an email channel, waits—perhaps realizing the email channel is likely to be less responsive than desired—and initiates a second work task via telephone. The second work task may be identical to the first work task, related to the first work task, or simply associated with the same customer as the first work task. An EWT associated with the email message, and optionally those work tasks with EWTs dependent upon the completion of the EWT, may be calculated by step 404.

Continuing the example, the second work task, such as on an email channel, is then combined and/or transferred to the telephonic channel. Step 406 determines the changes and step 408 calculates the second ETW. As one less email channel work task and one more telephonic work task, results, step 410 may then update at least one customer.

In a further embodiment, the customer engaged in a current work task (e.g., speaking to an agent) for one work task, and then a second work task is brought into the same channel, the EWT may be calculated by step 408 and in step 410 the customer may be notified, on the call, of the EWT for the second work task. For example, an agent may inform the customer, “I see you have an email asking about X. I would be happy to help you with that. You're call on Y should take us about three minutes and then we'll get to X.”

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
identifying a first work task for which an estimated wait time will be determined;
identifying a set of work tasks received by a contact center having a higher priority to the first work task;
determining, for each work task within the set of work tasks, an estimated time to complete that is based on each work task being processed by a single multi-tasking agent;
based on the estimated time to complete determined for each work task within the set of work tasks, determining the estimated wait time for the first work task; and
communicating the estimated wait time for the first work task to a first customer associated with the first work task.

2. The method of claim 1, wherein each of the set of work tasks is associated with a second customer.

3. The method of claim 2, wherein the estimated time to complete determined for each work task within the set of work tasks comprises the time to complete all of the set of work tasks.

4. The method of claim 2, wherein at least one work task of the set of work tasks is associated with a second customer and at least one work task of the set of work tasks is associated with a third customer.

5. The method of claim 4, wherein the estimated time to complete determined for each work task within the set of work tasks comprises a minimum time to complete one of the set of work tasks.

6. The method of claim 1, wherein at least one of the set of work tasks comprises a set of discrete subtasks and wherein the method further comprises determining, for each of the set of subtasks of the at least one of the set of work tasks, the estimated time to complete that is based on each subtask being processed by the single multi-tasking agent.

7. The method of claim 1, wherein determining, for each work task within the set of work tasks, the estimated time to complete that is based on each work task being processed by a plurality of multi-tasking agents.

8. The method of claim 7, wherein the estimated time to complete determined for each work tasks within the set of work tasks comprises the time to complete all of the set of work tasks processes by one of the plurality of multi-tasking agents.

9. The method of claim 1, further comprising, determining the estimated time to complete a work task within the set of work tasks, wherein the set of work tasks comprises at least two work tasks with different media types, being processed by the single multi-tasking agent having a performance determined in part by the media type.

10. The method of claim 1, further comprising, determining, for at least one work task within the set of work tasks, an estimated time to complete that is based a first channel via which the at least one work task was received.

11. The method of claim 10, further comprising, determining, for at least one work task within the set of work tasks, an estimated time to complete that is based transferring the at least one work task to a second channel for processing.

12. A system, comprising:
a processor; and
a communications interface; and
wherein the processor is configured to:
send and receive data via the communications interface;
identify a set of work tasks received by a contact center having a higher priority to a first work task;
determine, for each work task within the set of work tasks, an estimated time to complete that is based on each work task being processed by a single multi-tasking agent;
based on the estimated time to complete determined for each work task within the set of work tasks, determining the estimated wait time for the first work task; and
communicate, via the communications interface, the estimated wait time for the first work task to a first customer associated with the first work task.

13. The system of claim 12, wherein the communications interface is operable to connect the processor to a number of communications channels operable to receive the first work task.

14. The system of claim 12, wherein each of the set of work tasks is associated with a second customer.

15. The system of claim 14, wherein the estimated time to complete determined for each work task within the set of work tasks comprises the time to complete all of the set of work tasks.

16. The system of claim 12, wherein at least one work task of the set of work tasks is associated with a second customer and at least one work task of the set of work tasks is associated with a third customer.

17. The system of claim 16, wherein the estimated time to complete determined for each work task within the set of work tasks comprises a minimum time to complete one of the set of work tasks.

18. A non-transitory medium with instructions thereon that when read by a computer cause the computer to:
identify a first work task for which an estimated wait time will be determined;
identify a set of work tasks received by a contact center having a higher priority to the first work task;
determine, for each work task within the set of work tasks, an estimated time to complete that is based on each work task being processed by a single multi-tasking agent;
based on the estimated time to complete determined for each work task within the set of work tasks, determine the estimated wait time for the first work task; and
communicate the estimated wait time for the first work task to a first customer associated with the first work task.

19. The medium of claim 19, wherein each of the set of work tasks is associated with a second customer and the estimated time to complete determined for each work task within the set of work tasks comprises the time to complete all of the set of work tasks.

20. The medium of claim 18, wherein at least one work task of the set of work tasks is associated with a second customer and at least one work task of the set of work tasks is associated with a third customer and wherein the estimated time to complete determined for each work task within the set of work tasks comprises a minimum time to complete one of the set of work tasks.
